(19) United States
(12) Patent Application Publication
(10) Pub. No.: US 2007/0040900 A1
(43) Pub. Date: Feb. 22, 2007

(54) System and Method for Configuring Routing of Video from Multiple Sources to Multiple Destinations of Videoconference Using Software Video Switch

(75) Inventor: Randy Castles, Austin, TX (US)

Correspondence Address: WONG, CABELLO, LUTSCH, RUTHERFORD & BRUCCULERI,;L.L.P., 20333 SH 249, SUITE 600, HOUSTON, TX, 77070, US

(73) Assignee: POLYCOM, INC., Pleasanton, CA (US)

(21) Appl. No.: 11/457,208

(22) Filed: Jul. 13, 2006

Related U.S. Application Data
(60) Provisional application No. 60/698,684, filed on Jul. 13, 2005.

(51) Int. Cl. H04N 7/14

(52) U.S. Cl. 348/14.08

(57) ABSTRACT

A videoconferencing unit allows a user to customize the routing and display of video and content from a plurality of sources to a plurality of destinations or display devices. Although described in terms of videoconferencing and related applications, the techniques described herein are equally applicable to any system in which it is desired to display multiple video sources using mulitple video display devices and/or multiple video display windows.

### CROSS-REFERENCE TO RELATED APPLICATIONS

This is a non-provisional of U.S. Provisional Application Ser. No. 60/698,684, filed 13 Jul. 2005, which is incorporated herein by reference and to which priority is claimed under 35 U.S.C. § 119.

### FIELD OF THE DISCLOSURE

The present invention relates generally to video conferencing and more particularly to configuring multiple displays or display windows to display various videoconference views, data, etc.

### BACKGROUND OF THE DISCLOSURE

Current videoconferencing systems can support multiple sources of video and content data as well as multiple display devices. For example, a single videoconference endpoint may transmit multiple views, such as a zoomed out view showing all participants, a zoomed in view showing a current speaker (“people”), and a separate view showing a computer-generated presentation or the like (“content”). When coupled with multiple other sites in a multipoint video conference and the availability of multiple displays and/or picture-in-picture or other multi-window displays at each endpoint, there are dozens if not more permutations for how these sources can be displayed.

However, prior art videoconferencing devices have typically supported only a finite number (typically two or three) monitors or display devices, with each device being hard wired to display a particular video source. If a user was dissatisfied with a particular configuration, the only choice was to reconnect the physical connections between the display and the videoconferencing unit or connect the monitors to the videoconferencing unit through a separate switch.

Therefore, what is needed in the art is a simple but powerful system and method for configuring the routing of a plurality of video sources to a plurality of displays and/or windows.

### SUMMARY OF THE DISCLOSURE

Disclosed herein are a system and a method that allow a user to fully customize the placement of video and content sources on a plurality of displays and/or in a plurality of display windows. Although described in terms of videoconferencing and related applications, the systems and techniques described herein are equally applicable to any system in which it is desired to display multiple video sources using mulitple video display devices and/or multiple video display windows.

The subject matter of the present disclosure is directed to overcoming, or at least reducing the effects of, one or more of the problems set forth above.

### BRIEF DESCRIPTION OF THE DRAWINGS

Preferred embodiments and other aspects of subject matter of the present disclosure will be best understood with reference to a detailed description of specific embodiments, which follows, when read in conjunction with the accompanying drawings, in which:

FIG. 1 illustrates a schematic of a videoconferencing unit according to certain teachings of the present disclosure.

FIG. 2 illustrates a configuration screen of a graphical user interface for configuring the routing and display of video data from multiple video sources to multiple video destinations and/or windows in accordance with certain teachings of the present disclosure.

FIG. 3 illustrates another configuration screen of the graphical user interface for configuring the handling of routing and display of video data to one of the video destinations.

While the subject matter of the present disclosure is susceptible to various modifications and alternative forms, specific embodiments thereof have been shown by way of example in the drawings and are herein described in detail. The figures and written description are not intended to limit the scope of the inventive concepts in any manner. Rather, the figures and written description are provided to illustrate the inventive concepts to a person skilled in the art by reference to particular embodiments, as required by 35 U.S.C. § 112.

### DETAILED DESCRIPTION

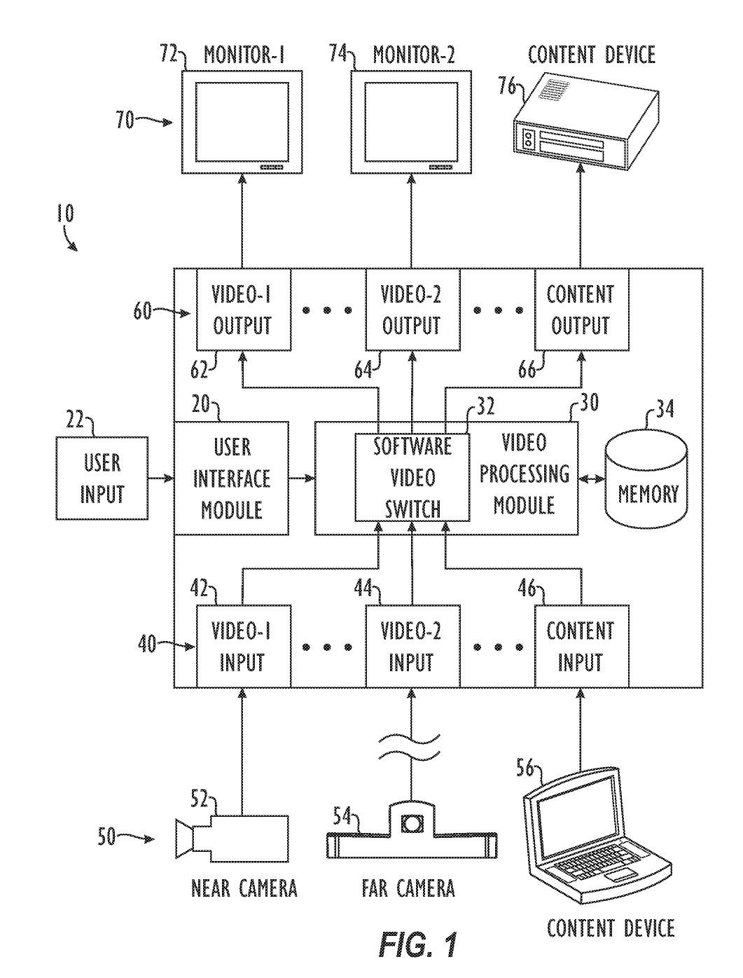

Referring to FIG. 1, a videoconferencing unit 10 according to certain teachings of the present disclosure is schematically illustrated. The videoconferencing unit 10 includes a user interface module 20, a video processing module 30, a plurality of video inputs 40, and a plurality of video outputs 60. The videoconferencing unit 10 is used to conduct a videoconference and includes a number of components, such as a network interface, encoders, decoders, audio components, and other components that are known in the art and are not shown for the sake of simplicity.

The video inputs 40 can include any conventional inputs for a videoconferencing unit. For example, the video inputs 40 can include composite video input, VGA input, S-Video input, Digital Video Interface (DVI) input, or other inputs for other suitable video signal standards. In addition, the video inputs 40 can include a network interface for receiving videoconferencing signals. The video for these input 40 can come from various video sources 50. In the present embodiment, a near camera source 52 that can be part of the unit 10 is coupled to a first video input 42, a far camera 54 of a remote videoconferencing unit participating in a videoconference is coupled to a second video input 44, and a content source 56 is coupled to a content input 46. The content source 56 can be a computer, a document camera, an annotation tool, or the like.

In a similar fashion, the video outputs 60 can include any of the conventional outputs for a videoconferencing unit. For example, the video outputs 60 can include RCA or BNC connectors for a composite video output, VGA output, S-Video output, DVI output, or other outputs for other suitable video signal standards. The video outputs 60 can be coupled to various video destinations 70, such as monitors, projectors, content recording devices (e.g., Video Cassette Recorders, Digital Versatile Disc recorders, computers, etc.), and other compatible devices. In the present embodiment, a first video output 62 is coupled to a first monitor 72, a second video output 64 is coupled to a second monitor 74, and a content output 66 is coupled to a content recording device 76.

The user interface module 20 can include conventional hardware and software components commonly used in the art of videoconferencing. The user interface module 20 receives user selections for configuring display of video. For example, a user can use a user input 22 coupled to the videoconferencing unit 10 to make their selections. The user input 22 can be a control panel, a keypad, a keyboard, a remote control, a touch screen display, etc. The video processing module 30 can include conventional hardware and software components commonly used in the art of videoconferencing. For example, the video processing module 30 can include video encoders and decoders, a control module, and other components known in the art. The video processing module 30 includes a software video switch 32 as one of its components. As its name implies, the software video switch 32 is a software component of the video processing module 30 operating on the videoconferencing unit 10 and is shown schematically in FIG. 1 as part of the video processing module 30 for illustrative purposes. The software video switch 32 can be implemented as program instructions stored on a programmable storage device for causing a programmable control device to perform operations according to the present disclosure. By manipulating the configuration of the software video switch 32, the user can customize the routing of video data from multiple sources 50 to each video destination 70 using a relatively straightforward approach.

The videoconferencing unit 10 disclosed herein solves difficult configuration problems related to displaying video from multiple video sources 50 on multiple video destinations 70 (e.g., multiple video devices and/or multiple windows associated with video devices). In one embodiment, for example, the user interface module 20 can include menu generators and graphical user interface software. The videoconferencing unit 10 determines which sources 50 of video data are coupled to the unit 10 and determines which destinations for video data (i.e., devices 70) are coupled to the unit 10. To make this determination, for example, the video processing module 30 can access a stored configuration from memory 34 that has a preconfigured set up of the videoconferencing unit 10. The configuration stored in memory 34 may contain indications of what video sources 50 and video destinations 70 have already been detected or have already been input as connected to the unit 10 by the user. Alternatively, the videoconferencing unit 10 can use techniques known in the art for automatically detecting devices connected to the unit 10, such as by exchanging specific messages with compatible devices connected to the unit 10.

After determining which sources 50 and destinations 70 for video are coupled to the videoconferencing unit 10, the user interface module 20 generates a configuration scheme that shows the sources 50 of video data relative to the video destinations 70. The configuration scheme is then displayed in a graphical user interface or a video screen that is output to one of the video destinations 70 (e.g., one of the local monitors 72 coupled to the videoconferencing unit 10). The user then uses the user input 22 to make selections from the displayed configuration scheme on how to configure handling of video with the videoconferencing unit 10. The user interface module 20 receives the user selection, and the software video switch 32 uses the user selection to configure automatic routing of video data from the sources 50 by the video processing module 30 to the one or more of the video destinations 70 coupled to the video outputs 60.

In general, the software video switch 32 can be configured to route video data from one or more of the video sources 50 to one or more of the video destinations 70. For example, the software video switch 32 can be configured to: (i) route video data from one of the video sources 50 to one or more of the video destinations 70, (ii) combine video data from two of the video sources 50 to one of the video destinations 70, and (iii) disable routing of video data from one or more of the video sources 50 to one or more of the video destinations 70. When configured to route video data from a single video source 50 to one or more video destinations 70, the software switch 32 independently sends video data to the video destinations 70. If the video destination receives video data from one source 50, then the received video signal may be used for the entire “display” of the destination device 70. As used herein, a “display” refers to an entire portion of a particular destination 70, such the entire screens of display devices or monitors 72 and 74. When configured to route video data from two or more video source 50 to one video destination 70, the software switch 32 can send combined video data from the sources 50 to be displayed in “windows” of the video destination 70. As used herein, a “window” refers to a sub-portion of a particular display device 70. For example, video data may be combined so that the video data from two or more video sources 50 can appear adjacent one another on the screen of one destination 70. Accordingly, the video data from each of the two or more sources 50 would occupy a “window” of the “display” of the video destination 70, although the videoconferencing unit 10 described herein would actually only be outputting a single display signal to the video destination 70. Consequently, the software video switch 32 of the videoconferencing unit 10 provides a virtual switching and compositing capability, which may be implemented in various combinations of hardware (i.e., the processing electronics), software, and/or firmware.

In a preferred embodiment for configuring the video switch 32, the video sources 50 are categorized into multiple categories. For example, video sources 50 in a video conference may be classified into one of three categories: (i) video from the local near side camera 52 (“local video”), (ii) video from any far endpoint camera 54 (“remote video”), and (iii) any content data including near, far, live, or still content (“content”) from a content source 56. In another embodiment, each category may be further sub-divided. For example, it might be desirable to assign each of a number of remote video sources 50 to a particular display device 70 configured to display remote video. Thus, as will be appreciated by one skilled in the art, the user selection input into the software video switch 32 can affect both the video switching and video mixing or compositing performed by the video processing module 30.

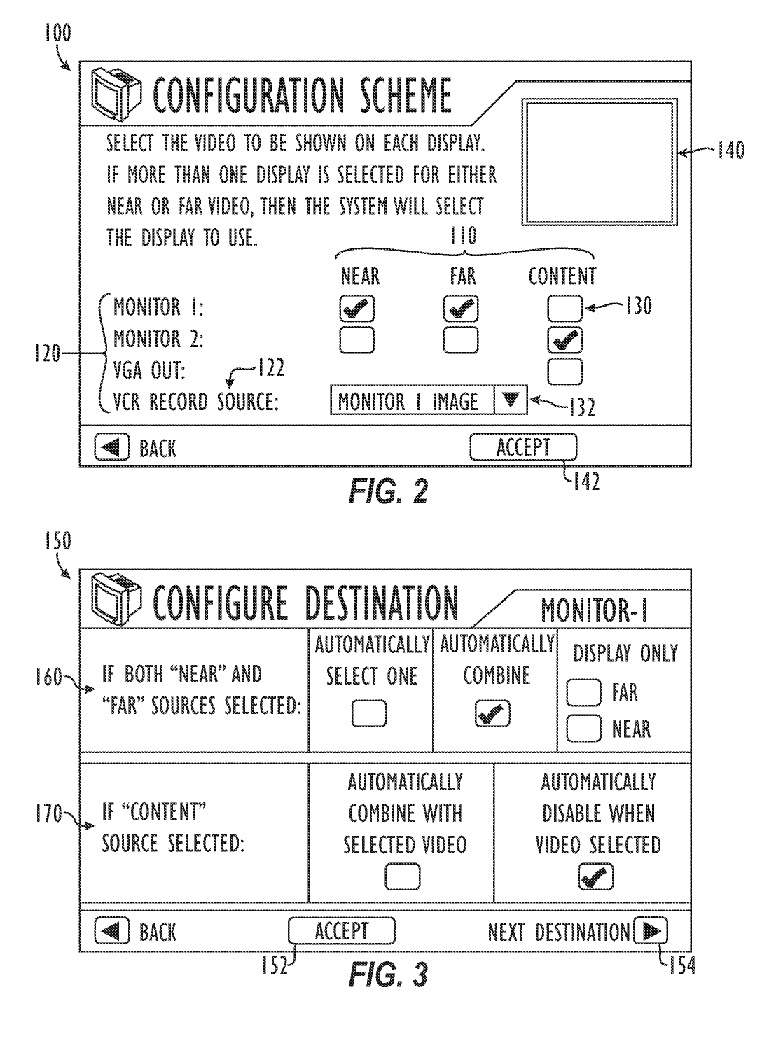

As noted above, a user can input selections on how to deliver video from the multiple video sources 50 to the display destinations 70 using the user interface module 20. In one embodiment, the user interface module 20 uses a graphical user interface to enable the user to make selections. Referring to FIG. 2, an exemplary embodiment of a configuration screen 100 of a user interface is illustrated. In the discussion that follows, reference is concurrently made to the element numerals for the components of FIG. 1 when appropriate.

The configuration screen 100 provides a scheme for a user to configure how the videoconferencing unit (10) will handle video between multiple sources (50) and destinations (70). In the present embodiment, the videoconferencing unit (10) has multiple video sources (50) and destinations (70). The video sources (50) are listed as sources 110 for providing video, and the destinations (70) are listed as destinations 120 for receiving video. The configuration screen 110 can also include a preview window 140 for displaying current video data.

In the present example, the destinations 120 for receiving video from the listed sources 100 include two display devices (denoted as Monitor-1 and Monitor-2), a VGA output (for driving a computer display), and a VCR for recording video data from a source. Each of these is a destination or “display” device (70) for purposes of the description herein. Depending on how the videoconferencing unit (10) is set up, other implementations of the videoconferencing unit (10) may have different destinations or display devices (70) listed on the configuration screen 100. As noted above, the destinations 120 for video data may be preconfigured, or the videoconferencing unit (10) may automatically detect which display devices are connected to it.

In the configuration screen 100, the video sources 110 of the video data are shown relative to the list of destinations 120 for video data. Preferably, at least some of the sources 110 are shown according to a plurality of categories rather than being listed according to a device corresponding to the source of video. The categories for the video sources 110 can be based on the type or location of the source of video. In the present example, the categories include “near,” “far,” and “content” video sources 110. As noted above, the “near” video source corresponds to video from a near-end camera (52) coupled to the videoconferencing unit (10), and the “far” video corresponds to the videoconference video received from far-end cameras (54) of other videoconference units coupled by a network input. As also noted above, the “content” video source corresponds to any content data including near, far, live, or still content (“content”) from a content source (56), such as a computer, document camera, etc.

For the categories of sources 110, some of the listed destinations 110 include checkboxes 130 for the user to select which source 110 is to be configured for display on the corresponding destination 120. Each display device destination 120 (e.g., Monitor-I and Monitor-2) includes checkboxes 130 for the local video (“Near”), the remote video (“Far”), and content data (“Content”). However, not all of the listed destinations 120 will necessarily show a checkbox 130 for each video source 110. For example, the “VGA output” destination 120 is suitable for driving a computer display so that it is more appropriate that the only source 110 for this “VGA output” destination 120 is that for content. Accordingly, only a checkbox 130 for the “content” category of sources 110 is listed for “VGA output” destination 120. In another example, the “VCR record source” destination 120 for recording video data is best linked to what is displayed on one of the other listed destinations 120 (i.e., display devices), such as what is shown on Monitor-1 or Monitor-2, for example. Linking the “VCR record source” destination 120 to one of the display device destinations 120 can be provide by a drop down 132 or the like.

Using a user input device (not shown), the user can select checkboxes 130 on the screen 100 to control the software switch (32) of the video processing module (30) and configure how video from the sources (50) is routed to the destinations (70) with the videoconferencing unit (10). As indicated in FIG. 2, for example, the videoconferencing unit (10) is currently configured for the destinations 120 named “Monitor-1” and “Monitor-2” to display “near” and/or “far” video. If no checkboxes 130 were selected for the “Monitor-2” destination 120 to receive video from any of the sources 110, for example, then the software video switch (32) of the videoconferencing unit (10) would disable routing of video data from the video sources to the “Monitor-2” destination 120. As also indicated in FIG. 2, “VGA output” destination 120 is configured to display “content” video so that the video switch (32) of the videoconferencing unit will route “content” data from a content source (56) to a VGA compatible display device (76) coupled to the VGA output of the videoconferencing unit (10). As indicated in FIG. 2, the output for VCR recording destination 120 is set to record the video image displayed on the “Monitor-1” destination 120 so that the software video switch (32) of the unit (10) will route “near” and/or “far” video to the VCR device coupled to one of the video outputs of the unit (10) in addition to routing “near” and/or “far” video to the “Monitor-1” destination (70) coupled to the unit (10).

After a user matches the video sources 110 with the video destinations 120 according to the arrangement they desire, the user can then select an “accept” button 142 to implement the configuration. The videoconferencing unit (10) can then provide configuration options for each destination 120 to allow or disallow video from each category. If more than one destination 120 is configured to display both “near” and “far” video sources 110, then the videoconferencing unit (10) may automatically select which one will show only the “near” video and which one will show only the “far” video, depending on the automatic set up of the videoconference unit (10). For example, the “Monitor-1” destination 120 may automatically be selected to show video from only the “near” source 110, while the “Monitor-2” destination 120 may automatically be selected to show video from only the “far” source 110. Otherwise, the videoconferencing unit (10) may be set up to automatically combine both “near” and “far” video sources on a given video destination 120. For example, the “Monitor-I” destination 120 may automatically be selected to show video from both the “near” and “far” sources 110 in adjacent “windows” on the display of the “Monitor-I” destination 120.

Referring to FIG. 3, an example configuration screen 150 for configuring how the videoconferencing unit (10) will automatically select certain video sources (50) for the destinations (70) is illustrated. In the present example, the screen 150 is set up for configuring the “Monitor-1” destination. The user can pre-configure the “Monitor-1” destination to handle the situation where multiple video sources (e.g., “near” and “far”) are selected to be output to it. In a first set up option 160, for example, the user can select whether to: (i) select one of the video sources (50) automatically with the videoconferencing unit (10), (ii) combine the selected video sources (50) automatically, or (iii) display only one selected video source (50). In a second set up option 170, for example, the user can select how to handle the situation where content is selected to be displayed on the “Monitor-1” destination. The user can select whether to: (i) automatically combine the “content” with the other selected video sources (50) or (ii) automatically disable the display of “content” when other video sources (50) are selected so that the content video can be output to a content destination, such as a VCR or DVD recorder. The configuration screen 150 can provide these and other forms of configuration for each video destination (70). Once done, the user can apply the selected configuration to the destination by selecting an accept button 152 and can go to another destination device (70) by selecting a next button 154. The configuration for the selected destination devices (70) will then be stored in memory (34) of the videoconferencing unit (10) and can be accessed during operation to control the routing of video data automatically based on the stored configuration.

As noted above, the user interface module 20 of FIG. 1 can have embedded software for displaying a graphical user interface “on-screen” (i.e., on a display or video destination coupled to the videoconference unit 10). Example configuration screens for such an “on-screen” graphical user interface have been discussed above with reference to FIGS. 2 and 3. In addition to or in the alternative of the “on-screen” graphical user interface, the user interface module 20 of FIG. 1 can use other techniques to enable a user to configure the videoconferencing unit 10. For example, the user interface module 20 can include a web interface that can connect via a network (e.g., Internet, servers, etc.) to a remote web browser with which a user can configure the videoconferencing unit 10. In another example, the user interface module 20 can include an application programming interface that can connect via a network, telnet, serial or other connection to an application on a computer with which a user can configure the videoconferencing unit 10. These other techniques can use configuration screens similar to those discussed above with reference to FIGS. 2 and 3.

The foregoing description of preferred and other embodiments is not intended to limit or restrict the scope or applicability of the inventive concepts conceived of by the Applicants. For example, the disclosed system can have a variety of configurations beyond the particular disclosed embodiments. In its most general form, the system disclosed herein allows a user to control the mapping of a number of video sources (e.g., near end video, far end video, content, etc.) to a number of video destination (e.g., display devices, monitors, VCRs, DVD records, far end videoconferencing units), wherein video data from multiple sources may be combined (i.e., mixed or composited on a particular device). In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A videoconferencing unit, comprising:
a plurality of video inputs configured to receive video data from a plurality of video sources;
a plurality of video outputs configured to output video data for a plurality of video destinations;
a user interface module configured to receive a user selected configuration; and
a video processing module coupled to the user interface module, the video inputs, and the video outputs, the video processing module having a software video switch, the video switch being configurable by the user selected configuration to perform one or more of
route video data from one of the video sources to one or more of the video destinations,
combine video data from two or more of the video sources for routing to at least one of the video destinations, and
disable routing of video data from one or more of the video sources to one or more of the video destinations.

2. The unit of claim 1, wherein at least one of the video inputs comprises a camera input configured to receive video data from a camera as one of the video sources.

3. The unit of claim 1, wherein at least one of the video inputs comprises a network interface configured to receive remote video data of a videoconference as one of the video sources.

4. The unit of claim 1, wherein at least one of the video inputs comprises a content input configured to receive video data from a content device as one of the video sources.

5. The unit of claim 1, wherein the user interface module comprises one or more of a graphical user interface for display on at least one of the video destinations coupled to one of the video outputs of the videoconferencing unit, a web interface for coupling to a network, and an application programming interface for coupling to an external application.

6. The unit of claim 5, wherein the graphical user interface comprises a configuration screen enabling the user to enter the user selected configuration.

7. The unit of claim 6, wherein configuration screen comprises:
a first listing of the video sources coupled to the video inputs;
a second listing of the video destinations coupled to the video outputs, the second listing being adjacent to the first listing; and
a plurality of user selectable regions to match one or more of the video sources of the first listing with one or more of the video destinations of the second listing.

8. The unit of claim 7, wherein the first listing of the video sources comprises a plurality of categories for the video sources, the categories including one or more of near video, far video, and content.

9. The unit of claim 7, wherein configuration screen comprises a user selectable drop down to match video data received from one of the video sources with one of the video destinations.

10. The unit of claim 1, wherein the software video switch is further configurable by the user selected configuration to automatically route video data from two or more of the video sources separately to two or more of the video destinations.

11. The unit of claim 1, wherein the software video switch is further configurable by the user selected configuration to automatically combine video data from two or more of the video sources for routing to at least one of the video destinations.

12. The unit of claim 1, wherein the video processing module is configured to automatically detect one or more of the video sources coupled to one or more of the video inputs of the videoconferencing unit.

13. The unit of claim 1, wherein the video processing module is configured to automatically detect one or more of the video destinations coupled to one or more of the video outputs of the videoconferencing unit.

14. The unit of claim 1, wherein the video processing module is configured to access a stored configuration of the videoconferencing unit, the stored configuration containing a first indication of one or more of the video sources coupled to the video inputs of the videoconferencing unit and containing a second indication of one or more of the video destinations coupled to the video outputs of videoconferencing unit.

15. A videoconferencing method, comprising:
determining a plurality of video sources and a plurality of video destinations of video data for a videoconferencing unit;
generating a configuration scheme showing the video sources relative to the video destinations;
displaying the configuration scheme in a graphical user interface;
receiving one or more user selections from the configuration scheme displayed in the graphical user interface;
configuring routing of video data from the video sources to the video destinations based on the one or more user selections; and
automatically processing video data of a videoconference for the videoconferencing unit according the configured routing.

16. The method of claim 15, wherein the act of automatically processing video data of the videoconference for the videoconferencing unit according the configured routing comprises one or more of
routing video data from one of the video sources to one or more of the video destinations;
combining video data from two or more of the video sources for routing to at least one of the video destinations; and
disabling routing of video data from one or more of the video sources to one or more of the video destinations.

17. The method of claim 15, wherein the act of generating the configuration scheme showing the video sources relative to the video destinations comprises:
listing the video sources in the configuration scheme;
listing the video destinations relative to the video sources in the configuration scheme; and
providing a plurality of user selectable regions in the configuration scheme to match one or more of the listed video destinations with one or more of the listed video sources.

18. The method of claim 17, wherein the act of listing the video sources in the configuration scheme comprises categorizing the video sources for the videoconferencing unit into a plurality of categories, the categories at least including near video, far video, and content.

19. The method of claim 15, wherein the act of generating the configuration scheme showing the video sources relative to the video destinations comprises providing a user selectable drop down in the configuration scheme to match video data received from one of the video sources with one of the video destinations.

20. The method of claim 15, wherein the act of configuring routing of video data from the video sources to the video destinations based on the one or more user selections further comprises automatically routing video data from two or more of the video sources separately to two or more of the video destinations.

21. The method of claim 15, wherein the act of configuring routing of video data from the video sources to the video destinations based on the one or more user selections further comprises automatically combining video data from two or more of the video sources for routing to at least one of the video destinations.

22. The method of claim 15, wherein the act of determining the plurality of video sources and the plurality of video destinations of video data for the videoconferencing unit comprises automatically detecting one or more of the video sources for the videoconferencing unit.

23. The method of claim 15, wherein the act of determining the plurality of video sources and the plurality of video destinations of video data for the videoconferencing unit comprises automatically detecting one or more of the video destinations for the videoconferencing unit.

24. The method of claim 15, wherein the act of determining the plurality of video sources and the plurality of video destinations of video data for the videoconferencing unit comprises accessing a stored configuration, the stored configuration containing a first indication of one or more of the video sources for the videoconferencing unit and containing a second indication of one or more of the video destinations for the videoconferencing unit.

25. A programmable storage device having program instruction stored thereon for causing a programmable control device to perform a method according to any one of claims 15 through 24.
